(19) United States
(12) Patent Application Publication
(10) Pub. No.: US 2012/0040183 A1
(43) Pub. Date: Feb. 16, 2012

(54) Cemented Carbide Compositions Having Cobalt-Silicon Alloy Binder

(75) Inventor: Rajendra Madhukar Kelkar, Bentonville, AR (US)

(73) Assignee: KENNAMETAL, INC., Latrobe, PA (US)

(21) Appl. No.: 12/854,367

(22) Filed: Aug. 11, 2010

(51) Int. Cl. C04B 14/48; B32B 9/00; B28B 1/00

(52) U.S. Cl. 428/367; 106/640; 106/643; 264/682; 156/60

(57) ABSTRACT

Cemented carbide compositions consisting essentially of tungsten carbide particles and a cobalt-silicon alloy binder are disclosed. Also disclosed are methods of making the cemented carbide compositions and articles which incorporate the cemented carbide compositions. Pellets having the cemented carbide compositions may be used in the uncrushed or crushed form. The cemented carbide compositions may also be used as metal cutting tool inserts, road construction tool inserts, oil or gas drill inserts, mining tool inserts, and as substrates for ultrahard materials, such as PCD, PCBN, and TSP.

### FIELD OF THE INVENTION

The present invention relates to cemented carbide compositions comprising hard particles of tungsten carbide and a binder phase comprising a cobalt-silicon alloy. The present invention also relates to articles comprising such cemented carbide compositions and methods of making such cemented carbide compositions and articles.

### BACKGROUND OF THE INVENTION

Since the 1920's, cemented carbides comprising hard particles of tungsten carbide (WC) and a cobalt (Co) as a binder have been used for applications such as metal cutting, metal forming, oil and gas drilling, road construction, and mining which require substantial strength, toughness, and wear resistance. From this starting point, a great amount of research, development, and production efforts have been invested in tailoring the properties of cemented carbides to meet the demands of industry and commerce. In many cases, the tungsten carbide particles have been supplemented by, and sometimes replaced by, other hard particles comprising, for example the carbides of titanium, vanadium, chromium, zirconium, hafnium, molybdenum, niobium, and tantalum. Similarly, the cobalt binder has been alloyed with, and in some case replaced by, various elements, e.g., nickel, iron, chromium, molybdenum, ruthenium, boron, tungsten, titanium, and niobium.

Nonetheless, cemented carbides consisting essentially of tungsten carbide hard particles and cobalt binder continue to be the workhorse of the industry. By varying the grain size of the tungsten carbide hard particles and the relative amounts of the tungsten carbide particles and cobalt binder a wide range of properties may be obtained. Very fine tungsten carbide particles sizes, e.g., under 1 micron, in combination with small amounts of cobalt binder, e.g., 6 weight percent or less, provide high hardness and wear resistance. In contrast, large tungsten carbide particles, e.g., over 30 microns, in combination with large amounts of cobalt binder, e.g., over 20 weight percent, provide high fracture toughness.

Indeed, tungsten carbide and cobalt are well suited to one another so that their combination in cemented carbides provides beneficial synergies. Most commonly, cemented carbide articles are manufactured by: (1) milling together tungsten carbide powder with cobalt powder to create a milled powder (sometimes referred to in the art as a graded powder); (2) forming the milled powder into a shaped article; (3) heating the article to a temperature at which liquid phase sintering occurs; and (4) cooling the article to room temperature. The combined effect of the milling of the tungsten carbide and cobalt powders and the diffusion that occurs during the heating of the compacted powder to the liquid phase sintering temperature results in the formation of a liquid well below the melting points of either the tungsten carbide or the cobalt. The liquid that forms is a solution in which cobalt can be considered a solvent and tungsten carbide a solute. The surface tension and the dissolving action of the liquid solution causes the tungsten carbide particles to rearrange and pull together thereby greatly increasing the density of the article. As the article is cooled from the liquid phase sintering temperature, the liquid solution solidifies. During the solidification, all or most of the dissolved tungsten carbide precipitates out of the solidifying liquid so that the solidified binder of the cemented carbide article is essentially cobalt.

In applications in which cemented carbides having very fine tungsten carbide grains are desired, it is known to include in the cemented carbide composition a combination of elements that will dissolve in the liquid at the sintering temperature and then precipitate out into very fine particles, thus inhibiting the grain growth of the tungsten carbide grains. For example, Japanese Published Applications Nos. 2003-193172, 2004-059946, and 2004-076049 teach the addition of small amounts of at least one of vanadium, chromium, tantalum, molybdenum, or their carbides, along with a small amount of silicon to dissolve in the binder phase and to subsequently act in preventing grain growth of the tungsten carbide particles.

Persons skilled in the art differentiate between cemented carbide articles that are produced by methods which include the steps of (a) milling the tungsten carbide and cobalt powders together into a milled powder and (b) compacting the milled powder by pressing from cemented carbide articles that are produced by methods which do not include these steps. In the methods which do include these steps, the pressure applied to the milled powder during pressing may be applied directionally along one or more axes or it may be applied isostatically. The most frequently employed methods that use both the milling and pressing steps are known in the art as press-and-sinter methods. In press-and-sinter methods, the pressing step is applied at room temperature and consolidates the powder to an apparent density of over about 60 percent. Less frequently used methods apply the pressing step at an elevated temperature, e.g., hot pressing, hot isostatic pressing, and rapid omnidirectional consolidation (ROC), and the sintering of the powder is done simultaneously with the application of the high pressure. There are also hybrid methods in which pressing is done at room temperature and then again either after or during sintering, e.g., the sinter-HIP process.

There are several methods that omit the milling and pressing steps. In some of these methods, the step of milling the powder is either replaced by a step of mixing the powder, e.g., in a vee-blender or a double cone blender, or is omitted altogether. One such method is to infiltrate a bed of sintered cemented carbide particles with a molten binder that contains cobalt, and then cool the infiltrated bed, solidifying the binder. Another such method is to mix together the tungsten carbide and cobalt powders, create a bed of the mixed powder, infiltrate the bed with a molten binder that contains cobalt, and then cool the infiltrated bed, solidifying the binder. A third is to create a molten eutectic composition of tungsten carbide and cobalt, cast the molten composition into a mold, and then cool to solidify the casting. In a fourth such method, the tungsten carbide and cobalt powder are mixed together, the mixed powder is placed into a mold and heated to melt the cobalt so that it infiltrates into the spaces between the tungsten carbide powder, and then the infiltrated powder mass is cooled to solidify the cobalt.

Examples of these four methods are disclosed in U.S. Published Application No. US 2008/0101977 A1. Persons skilled in the art will recognize that the teachings of this published application go well beyond the making of cemented carbides consisting essentially of tungsten carbide and a cobalt binder. This published application teaches that the hard particles may be one or more carbides, oxides, borides, silicides, nitrides, cast tungsten carbide (WC, W₂C), cemented carbides, mixtures thereof, and solid solutions thereof. It teaches that the cemented carbide hard particles may comprise at least one of titanium, zirconium, vanadium, niobium, tantalum, chromium, molybdenum, and tungsten. It also teaches that the binder phase may be composed of one or more of the Group VIII metals, namely cobalt, nickel, and/or iron and may include additives, such as boron, chromium, silicon, aluminum, copper, manganese, or ruthenium in total amounts of up to 20 weight percent of the binder phase. The published application teaches the use of eutectic binders in these methods. It gives examples of binders having compositions of (a) cobalt with 2 weight percent boron, (b) cobalt with 45 weight percent tungsten carbide, (c) nickel with 45 weight percent tungsten carbide and 2 weight percent boron, (d) nickel with 3.7 weight percent boron, (e) nickel with 11.6 weight percent silicon, and (f) cobalt with about 12.5 weight percent silicon.

In addition to being used to monolithically constitute an article, cemented carbides are also used to form pellets. The pellets may be used as hard particles in combination with a binder either as part of a composite article or as a hardfacing that is applied to the surface of an article. Examples of the methods used for making cemented carbide pellets are taught by U.S. Pat. No. 7,128,773.

Despite the great developments that have been made to date in cemented carbides, the ever increasing demands of industry continue to require the development of new and better grades of cemented carbide.

### SUMMARY OF THE INVENTION

The inventor of the present invention has made the surprising discovery that articles comprising cemented carbide consisting essentially of tungsten carbide hard particles and a cobalt binder have improved wear resistance when the binder is a cobalt-silicon alloy. The inventor has also discovered the surprising result that, in some cases, such cemented carbides have improved combinations of fracture toughness and wear resistance properties.

Preferably, the amount of silicon in the cobalt-silicon alloy binder is in the range of about 1 to about 21 weight percent. Without intending to be bound, the inventor believes that the silicon goes into solution in the liquid and forms in the solidified binder and/or on the tungsten carbide particles one or more phases which act to increase the wear resistance of the cemented carbide. The silicon also has the beneficial effect of lowering the temperature at which liquid phase sintering can be accomplished, thus allowing for lower sintering temperatures to be used. The use of lower sintering temperatures results in energy and cost savings in producing the cemented carbide articles and lowers the driving force for grain growth so that the articles may have smaller tungsten carbide grain sizes.

The present invention includes cemented carbide compositions consisting essentially of tungsten carbide hard particles and a cobalt-silicon alloy binder. The present invention also includes methods of making cemented carbide compositions consisting essentially of tungsten carbide hard particles and a cobalt-silicon alloy binder. The present invention also includes methods of making articles comprising such cemented carbides, e.g., cutting tools for machining, road construction, oil and gas drilling, and mining applications.

The present invention also includes cemented carbide pellets consisting essentially of tungsten carbide hard particles and a cobalt-silicon alloy binder, in either an uncrushed or crushed form. The present invention also includes the use of such cemented carbide pellets in metal matrix body compositions, hardfacing compositions, and in hardfacing rods.

The present invention also includes substrates for ultrahard material articles, e.g., articles comprising polycrystalline diamond, polycrystalline cubic boron nitride, and the like, wherein the substrate consists essentially of tungsten carbide hard particles and a cobalt-silicon alloy binder. Such substrates may be attached to the during or subsequent to the formation of the ultrahard material article. The relatively low melting points of the cobalt-silicon alloys advantageously decrease the likelihood of damage to the ultrahard particles, e.g., by graphitization and thermal mismatch.

### BRIEF DESCRIPTION OF THE DRAWINGS

The criticality of the features and merits of the present invention will be better understood by reference to the attached drawings. It is to be understood, however, that the drawings are designed for the purpose of illustration only and not as definitions of the limits of the present invention.

FIG. 1 is a schematic of a perspective view of a cutter element in accordance with an embodiment of the present invention.

FIG. 2 is a graph showing the improvement of wear resistance of cemented carbides in accordance with the present invention as a function of binder silicon content.

FIG. 3 is a graph showing the relationship of fracture toughness to wear resistance for conventional cemented carbides (diamonds) and cemented carbides according to embodiments of the present invention (triangles).

FIG. 4 is a schematic elevational drawing, partially in cross-section, of a roller cone bit having cemented carbide inserts made in accordance with an embodiment of the present invention.

FIG. 5 is a schematic elevational drawing of a fixed cutter element, having PCD, PCBN, or TSP inserts, made in accordance with an embodiment of the present invention.

### DESCRIPTION OF PREFERRED EMBODIMENTS OF THE INVENTION

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims.

Unless otherwise noted, all compositions are expressed in terms of weight percent. The term “melting point” is to be construed as referring to the temperature at which liquid first appears upon heating a composition. The term “cobalt-silicon alloy” is to be construed as referring to the combined cobalt and silicon content of the inventive cemented carbides, whether or not in the state of the cemented carbide then under consideration the silicon is actually alloyed with the cobalt. This term is being used as a matter of convenience because of the descriptive difficulty presented by the fact that the locus of the silicon in the composition changes with the processing history of the composition. Thus, the amount of silicon is described as comprising a certain part of the “cobalt-silicon alloy” regardless of whether the silicon is then presently, in whole or in part, in solution with the cobalt or as a component of a phase comprising cobalt-silicon, tungsten-silicon, or cobalt-tungsten-silicon.

Cemented carbides according to embodiments of the present invention consist essentially of tungsten carbide particles and a cobalt-silicon alloy binder. The tungsten carbide particles may make up about 60 to 99 percent of the cemented carbide. In the sintered cemented carbide, the tungsten carbide particles may have average particle sizes ranging from about 0.2 to about 12 microns. Preferably, the particle size of the tungsten carbide particles is in the range of from about 0.5 to about 7 microns, and more preferably within the range of from about 0.6 to about 5 microns.

The cemented carbides according to embodiments of the present invention have between about 1 and about 40 percent cobalt-silicon binder. Preferably, the amount of cobalt-silicon binder is between about 3 to about 30 as binder amounts outside of this range are more difficult to sinter.

The cobalt-silicon alloy may contain from about 1 to about 21 percent silicon. Silicon levels below this range do not significantly improve the wear resistance and silicon levels above this range may lead to an undesirable levels of porosity and/or brittleness. Preferably, the silicon level is in the range of from about 2 to about 13 percent and more preferably in the range of about 11 to about 12 percent in order to obtain preferred combinations of toughness, wear resistance, transverse rupture strength, and hardness.

In some preferred embodiments of the present invention, the cemented carbides are made by providing a milled powder comprising tungsten carbide, cobalt, and silicon. The milled powder may be produced by milling together tungsten carbide powder with cobalt powder and silicon powder using conventional ball milling or attritor milling techniques. The milled powder may also include a pressing aid or a polymer or wax binder. In some embodiments of the present invention in which the milled powder is to be die pressed or isostatically pressed, the milled powder is preferably granulated by a conventional technique, e.g., by vacuum drying or spray drying. The average particle size of the tungsten carbide powder used in these methods is preferably in the range of from about 0.6 to about 40 microns, as measured by the Fisher Sub-Sieve Size method.

In accordance with the present invention, the silicon may be added as an elemental powder to the cobalt and tungsten carbide powders and these powders are milled together to create the milled powder mixture. The silicon may also be provided, at least in part, in the form of a silicon-cobalt alloy powder which is then used in making the milled powder mixture.

In some embodiments of the present invention wherein a cemented carbide article is made, the milled powder is pressed in a mold under pressure to form a precursor of the desired article. The pressed milled powder is sometime referred to in the art as a “compact” or a “green article” or a “green part” or a “green pressing”, the term “green” indicating that the pressed powder has not been partly or completely sintered together by heating. The pressure may be applied by any conventional powder metallurgical pressing method. If desired, the compact may be shaped by machining or solid phase sintered to improve its strength and then machined. The as-pressed or as-machined compact may be then be liquid phase sintered in a conventional sintering furnace. In some embodiments of the present invention, the sintered compact may be hot isostatically pressed to enhance its densification. It is also within the contemplation of the present invention that hot pressing, hot isostatic pressing, or the ROC process be used to simultaneously compact and liquid phase sinter the milled powder to form a sintered article. It is preferred that during the high temperature processing that the compact be separated from graphite components or fixtures by an inert medium.

The cemented carbides of the present invention may be used to make any article which may be made from conventional tungsten carbide/cobalt cemented carbides. In making such articles, the compositional and processing parameters of the cemented carbide of the present invention may be identical to those used for conventional cemented carbides. For example, the tungsten carbide grain size and amount of cobalt may be kept the same as in the conventional tungsten carbide. Although conventional sintering temperatures and times may be employed with the cemented carbides of the present invention, the melting point depressant effect of the silicon in the cobalt-silicon alloy binder makes it possible to use lower temperatures and/or shorter liquid phase sintering times to achieve comparable levels of sintering. Alternatively, the same liquid phase sintering conditions can be used for an article made with a cemented carbide of the present invention as is used for the article made with a conventional cemented carbide, but the amount of binder phase may be reduced in the inventive cemented carbide to produce the same amount of liquid phase.

The lower liquid phase sintering temperature of the cemented carbides of the present invention as compared to that of a conventional cemented carbides having the same amount of binder may be particularly advantageous when the inventive cemented carbide is used as a substrate for an article comprising an ultrahard material. Examples of ultrahard materials are polycrystalline diamond (“PCD”), polycrystalline cubic boron nitride (“PCBN”), and thermally stable polycrystalline diamond (“TSP”), all of which are defined and described in detail in US 2009/0313908 A1 and those definitions are to be used herein.

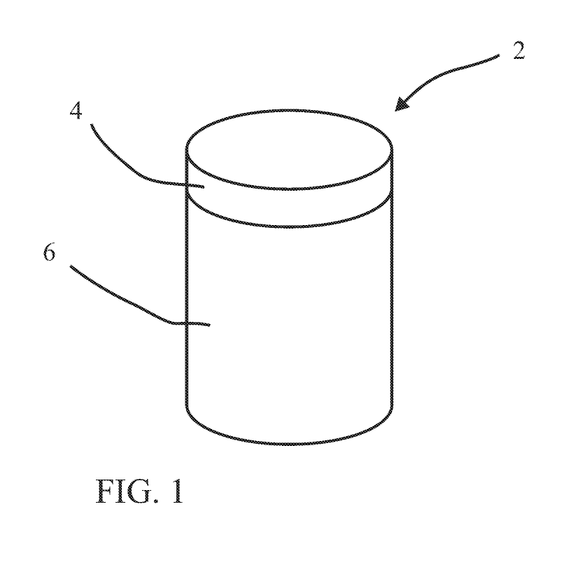

An example of an ultrahard material article attached to a cemented carbide substrate in accordance with an embodiment of the present invention is shown schematically in FIG. 1. There, the cutter element 2 consists of a PCD, PCBN, or TSP cutting portion 4 attached to a cemented carbide substrate 6.

In accordance with some embodiments of the present invention, the ultrahard material may be attached to the inventive cemented carbide substrate either during or subsequent to the process in which the ultrahard material is formed. All methods known in the art for attaching ultrahard materials to cemented carbide substrates are within the scope of the present invention. Some methods which are suitable for making such attachments are described in detail in the aforementioned US 2009/0313908 A1.

For example, an ultrahard article comprising PCD may be formed directly on the surface of a substrate of a cemented carbide of the present invention by placing a mass of natural or synthetic diamond particles on the surface of the substrate and then subjecting the combination to a high temperature, high pressure process (“HTHP”) for a suitably long time to consolidate the particles. During the HTHP process, the cobalt-silicon alloy binder of the substrate liquifies and some of it may infiltrate into the particle mass and catalyze the sintering of the particles together. Because the cobalt-silicon alloy binders of the present invention melt at lower temperatures than do conventional cobalt binders, the present invention makes it is possible to use lower temperatures in the HTHP process. Furthermore, since, typically, the pressure applied in the HTHP process is proportional to the temperature used, the present invention also permits the pressure to be lower. The lower temperature and pressure not only provide energy savings, but also make it possible to use less expensive equipment in the HTHP process. The lower temperatures may also help to reduce damage to the ultrahard material which may occur by way of graphitization and thermal mismatch mechanisms. Without wishing to be bound, the inventor suggests that the silicon of the cobalt-silicon alloy binder may encourage the formation of silicon carbide and TSP.

Sometimes the process of attaching an already formed ultrahard material article to a cemented carbide substrate is referred to in the art as “reattachment”, especially in the case where the ultrahard material substrate was originally formed on a cemented carbide substrate and then removed for leaching out the catalytic material that was used to aid sintering together the ultrahard material particles to form the ultrahard material article. Persons skilled in the art will recognize that the advantages springing from the cobalt-silicon alloy binder described above with regard to forming an ultrahard article directly on the inventive cemented carbide substrate by HTHP apply with equal force when HTHP is employed to attach or reattach an already formed ultrahard material article to a substrate comprising a cemented carbide of the present invention.

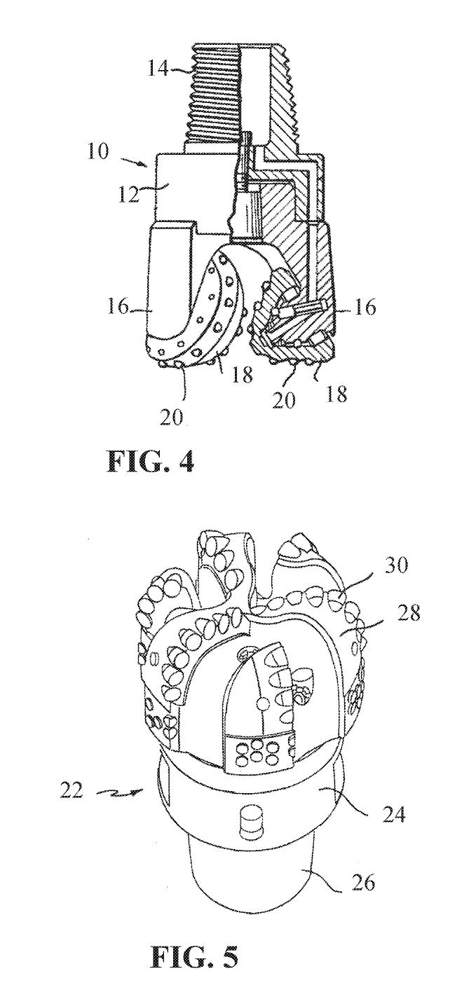

Other examples of articles which may be made of the cemented carbides of the present invention include metal cutting tool inserts, road construction tool inserts, oil or gas drill inserts, and mining tool inserts. Examples of such inserts are illustrated in the earth drilling bits shown in FIGS. 4 and 5. In earth boring drills, e.g., those which are used for oil and gas drilling, a drill bit having independently rotating components is used where the rock formations are hard. FIG. 4 shows an example of a roller cone bit, or rotary cone cutter, 10 (shown partly in cross-section). The roller cone bit 10 has a relatively stationary body 12 which is attached to the drill line by threaded end 14. A plurality of legs 16 depend from the body 12. Each of the legs 16 rotatably carries a rolling cone 18. Each rolling cone 18 has fixed to it a plurality of inserts 20, which preferably are tungsten carbide inserts of the present invention. Referring now to FIG. 5, there is shown fixed cutter element 22, which is an example of an earth drilling bit which has no independently rotating components. Fixed cutter element 22 has a body 24 which has a connector end 26 for attaching to a drill line. The body 24 carries a plurality of cutter blades 28, which, in turn, carry a plurality of inserts 30. The inserts 30 preferably comprise an ultrahard material, e.g., PCD, PCBN, or TSP, attached to a cemented carbide substrate of the present invention.

In some other embodiments of the present invention, the milled powder of the inventive cemented carbide composition is formed into granules or pellets. It is to be understood that in the art the term “granule” is often used in the art to refer to cemented carbide particles having sharp or angular body features whereas the term “pellet” is often used to describe those having rounded body features. For the sake of simplicity of description, the term “pellet” is to be construed hereinafter and in the appended claims to include both granules and pellets. The pellets may be formed by any method known in the art. For example, the milled powder, containing a polymer or wax binder, may be pressed through a screen to form green seeds which are then pan pelletized and screened to yield a desired size distribution. The green pellets are then liquid phase sintered. The sintering usually agglomerates the pellets, and these agglomerates are crushed to break apart the pellets which are then screened to a desired size distribution. Alternatively, the pellets may be produced by making sintered articles and then crushing the sintered articles and screening the crushings to a desired size distribution.

Although any composition of the inventive cemented carbide described above may be used for the pellets, the cobalt silicon alloy binder of pellets according to the present invention preferably has a silicon level in the range of from about 1 to about 15 percent. Also, it is preferred that the amount of the pellet binder, i.e., the cobalt silicon alloy binder in the pellets, is in the range of from about 1 to about 10 percent.

The pellets of the present invention may be used for any application for which conventional cemented carbide pellets are used, either in uncrushed or crushed form. For example, the pellets may be used as a component of any conventional hardfacing composition as a full or partial substitute for conventional cemented carbide pellets. Preferably, the amount of pellet binder is in the range of about 1 to about 10 percent. As another example, the pellets of the present invention may be disposed within an arc hardfacing rod, preferably along with a flux and other components, such as silicon-manganese alloy powder or niobium-containing powder and a phenolic resin. The outer portion of the arc hardfacing rod may be steel or some other suitable material which helps to form the hardfacing binder for the inventive pellets. Examples of such arc hardfacing rods into which the pellets of the present invention may be substituted for conventional cemented carbide pellets are described in U.S. Pat. No. 5,250,355.

The following examples are given for illustration of some preferred embodiments of the present invention, but are not to be construed as limiting the present invention.

### EXAMPLES

### Examples 1-4 and Comparative Samples 1-2

Four milled powders according the present invention were prepared as 5 kilogram ball mill batches using the compositions listed in Table 1 for Examples 1-4. In making each ball mill batch, the relevant amounts of the following powders were weighed out: (a) tungsten carbide powder having an average particle size of 10 microns (as measured by the Fisher Subsieve Size method); (b) cobalt powder (99.5 percent purity) having an average particle size of 1.3 microns; and silicon powder (99.5 percent purity) and a d(90) particle size of 6.5 microns. The powders were placed in a steel ball mill jar along with 17 kilograms of tungsten carbide capsule-shape media, 1.6 liters of heptane, and 100 grams of paraffin. Each ball mill batch was milled for 6 hours and then dried. The milled powder was used to press specimens for transverse rupture, fracture toughness, and wear test bars. The compacts were placed in a sinter-HIP furnace under vacuum and heated to remove the wax binder and then heated further to the liquid phase sintering temperature of 1425° C. under an argon pressure of 5.5 megaPascals and then cooled to room temperature.

Two comparative milled powders were made and evaluated using the conditions used for Examples 1-4. The compositions of these milled powders are given in Table 1 as Competitive Samples 1 and 2.

Differential scanning calorimetry (“DSC”) analysis was conducted on samples of the milled powder of Examples 1-4 and Comparative Samples 1 and 2. The tests were conducted using a Netzsch calorimeter. The results of these tests are presented in Table 1. The melting temperatures reported in Table 1 are the temperatures at which the DSC trace indicated that melting first occurred. The data shows that the silicon in the cemented carbides of the present invention significantly lowered the melting temperature in comparison to the comparative samples having the same cobalt content.

TABLE 1

| | | Binder Silicon | Melting |
|---|---|---|---|
| | | Content | Temperature |
| Sample ID | Sample Composition (%) | (%) | (° C.) |
| Ex. 1 | WC—6Co—0.5Si | 7.7 | 1294 |
| Ex. 2 | WC—6Co—2.0Si | 25.0 | 1244 |
| Ex. 3 | WC—16Co—0.5Si | 3.0 | 1357 |
| Ex. 4 | WC—16Co—2.0Si | 11.1 | 1180 |
| Comp. 1 | WC—6Co | 0 | 1375 |
| Comp. 2 | WC—16Co | 0 | 1383 |

Appropriate physical test specimens were prepared from sintered compacts of Examples 1-4 and Comparative Examples 1 and 2 for measuring the hardness, transverse rupture strength (“TRS”), wear resistance, the fracture toughness, relative density, and porosity. The hardness was measured on the Rockwell A hardness scale in accordance with ASTM Standard B294 (higher values mean indicate greater hardness). The transverse rupture strength was measured by a three-point bending test using rectangular samples of 5.1 millimeters (0.20 inch) by 6.4 millimeters (0.25 inch) by 19.1 millimeters (0.75 inch) in accordance with ASTM Standard B406 (higher values indicate higher strength). The wear resistance was measured in accordance with ASTM Standard B611 (higher values indicate better wear resistance). The fracture toughness was measured using a modified ASTM E399 test (higher values indicate greater toughness). The density was measured in accordance with ASTM B311. The porosity was evaluated according to ASTM B276 (lower numbers beside the A and B letters indicates a denser microstructure and beside the C letter indicates less free carbon). The results of the tests are reported in Table 2.

TABLE 2

| | | Binder | | | Wear | Fracture | | |
|---|---|---|---|---|---|---|---|---|
| | | Si | | | Resistance | Toughness | | |
| Sample | | Content | Hardness | TRS | (B611 | K_{IC} | Density | |
| ID | Binder | (%) | (HRA) | (MPa) | No.) | (MPa-m^{0.5}) | (g/cc) | Porosity |
| Ex. 1 | 6Co—0.5Si | 7.7 | 89.4 | 2,055 | 10 | 14.3 | 14.78 | A02B00 |
| | | | | | | | | C00 |
| Ex. 2 | 6Co—2.0Si | 25.0 | 82.4 | 607 | 2 | 6.6 | 12.73 | A08B08 |
| | | | | | | | | C00 |
| Ex. 3 | 16Co—0.5Si | 3.0 | 84.5 | 2,910 | 2 | 23.1 | 13.31 | A02B00 |
| | | | | | | | | C00 |
| Ex. 4 | 16Co—2.0Si | 11.1 | 85.4 | not | 3 | 19.8 | 12.79 | A02B00 |
| | | | | meas. | | | | C04 |
| Comp. 1 | 6Co | 0 | 89.0 | 2,951 | 6 | 16.5 | 14.94 | A02B00 |
| | | | | | | | | C00 |
| Comp. 2 | 16Co | 0 | 86.1 | 3,068 | 2 | 19.8 | 13.85 | A02B00 |
| | | | | | | | | C00 |

Sintered samples of Examples 1-4 and Comparative Samples 1 and 2 were examined by X-ray diffraction at 45 kiloelectronvolts and 40 milleamps to determine the crystalline phases present. The results of these tests are reported in Table 3, which reports the phases identified other than tungsten carbide and cobalt

TABLE 3

| | | | Phases Identified by |
|---|---|---|---|
| | | Binder Si | X-ray Diffraction |
| Sample | | Content | Other Than WC |
| ID | Sample Composition (%) | (%) | and Co |
| Ex. 1 | WC—6Co—0.5Si | 7.7 | Si₂W |
| Ex. 2 | WC—6Co—2.0Si | 25.0 | CoSi |
| Ex. 3 | WC—16Co—0.5Si | 3.0 | none |
| Ex. 4 | WC—16Co—2.0Si | 11.1 | Si₂W |

### Examples 5-8

Samples were made for Examples 5-8 in the same manner used for Examples 1-4, except that tungsten carbide powder had an average particle size of 3.5 microns. The compositions of Examples 5-8 are given in Table 4 along with the physical properties measured for these samples.

TABLE 4

| | | Binder | | | Wear | Fracture | |
|---|---|---|---|---|---|---|---|
| | | Si | | | Resistance | Toughness | |
| Sample | | Content | Hardness | TRS | (B611 | K_{IC} | Density |
| ID | Composition | (%) | (HRA) | (MPa) | No.) | (MPa-m^{0.5}) | (g/cc) |
| Ex. 5 | WC—6Co—0.25Si | 4.0 | 90.9 | 2,882 | 18 | 12.3 | 14.89 |
| Ex. 6 | WC—6Co—1Si | 14.3 | 91.1 | 1,034 | 29 | 9.9 | 14.62 |
| Ex. 7 | WC—10Co—0.25Si | 2.4 | 89.3 | 2,992 | 6 | 14.9 | 14.39 |
| Ex. 8 | WC—10Co—1Si | 9.1 | 90.0 | 1,848 | 11 | 13.2 | 14.21 |

### Examples 9-12

Samples were made for Examples 9-12 in the same manner used for Examples 1-4. The compositions of Examples 9-12 are given in Table 5 along with the physical parameters measured for these samples.

TABLE 5

| | | Binder | | | Wear | Fracture | |
|---|---|---|---|---|---|---|---|
| | | Si | | | Resistance | Toughness | |
| Sample | | Content | Hardness | TRS | (B611 | K_{IC} | Density |
| ID | Composition | (%) | (HRA) | (MPa) | No.) | (MPa-m^{0.5}) | (g/cc) |
| Ex. 9 | WC—6Co—0.25Si | 4.0 | 89.2 | 1,538 | 6 | 16.2 | 14.90 |
| Ex. 10 | WC—6Co—1Si | 14.3 | 86.6 | 676 | 8 | 13.5 | 14.23 |
| Ex. 11 | WC—10Co—0.25Si | 2.4 | 87.3 | 2,455 | 6 | 20.1 | 14.47 |
| Ex. 12 | WC—10Co—1Si | 9.1 | 88.2 | 2,041 | 7 | 17.6 | 14.24 |

### Example 13

A sample was made for Example 13 in the same manner used for Examples 1-4, except that tungsten carbide powder had an average particle size of less than 1 micron. The composition of Example 13 is given in Table 6 along with the physical parameters measured for this sample.

TABLE 6

| | | Binder | | | Wear | Fracture | |
|---|---|---|---|---|---|---|---|
| | | Si | | | Resistance | Toughness | |
| Sample | | Content | Hardness | TRS | (B611 | K_{IC} | Density |
| ID | Composition | (%) | (HRA) | (MPa) | No.) | (MPa-m^{0.5}) | (g/cc) |
| Ex. 13 | WC—6Co—0.25Si | 7.7 | 93.0 | 4,454 | 92 | 8.2 | 14.90 |

### Examples 14-16

Samples were made for Examples 14-16 in the same manner used for Examples 1-4, except that the liquid phase sintering temperature was varied. The compositions of Examples 9-12 are given in Table 7 along with relevant liquid phase sintering temperatures used for sintering these samples and the physical parameters measured for these samples.

TABLE 7

| | | Binder | | | | Wear | Fracture | |
|---|---|---|---|---|---|---|---|---|
| | | Si | Sinter | | | Resistance | Toughness | |
| Sample | | Content | Temp. | Hardness | TRS | (B611 | K_{IC} | Density |
| ID | Composition | (%) | (° C.) | (HRA) | (MPa) | No.) | (MPa-m^{0.5}) | (g/cc) |
| Ex. 14 | WC—6Co—0.5Si | 7.7 | 1350 | 89.6 | 1,882 | 11 | 13.2 | 14.80 |
| Ex. 15 | WC—16Co—0.5Si | 3.0 | 1350 | 84.5 | 2,888 | 2 | 22.0 | 13.34 |
| Ex. 16 | WC—16Co—2Si | 11.1 | 1225 | 86.1 | 1,993 | 4 | 18.7 | 12.88 |

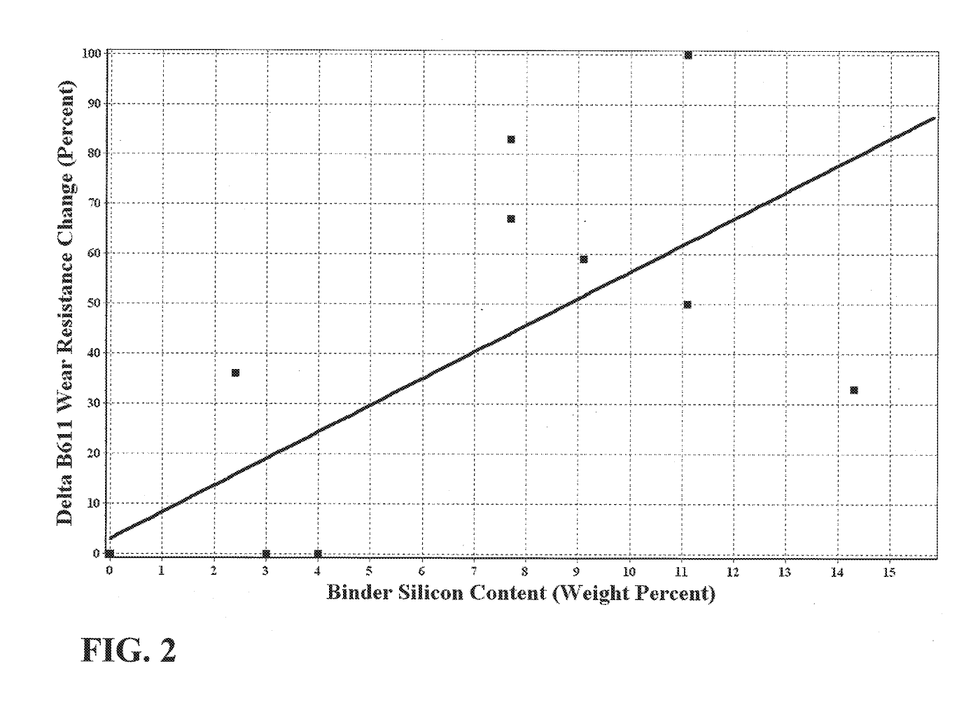

The inventor of the present invention discovered the surprising result that the use of a cobalt-silicon binder in tungsten carbide/cobalt cemented carbide results in significantly improved wear resistance. Referring to FIG. 2, there is shown a plot of the improvement of the wear resistance values as a function of binder silicon content for the samples which were made with a starting tungsten carbide having a particle size of 10 microns. In this plot, the B611 wear resistance values of the Examples having 6 percent cobalt and 16 percent cobalt were normalized to those of the comparative sample having the same cobalt content. In the case of Examples having 10 percent cobalt, a wear resistance value was straight-line interpolated for this cobalt level based upon the wear resistance values of the comparative samples and this interpolated B611 value (4.4) was used to normalize the wear resistance values of these Examples. The solid line sloping upwardly to the right shows the function derived by linear regression analysis of the relationship of the change in wear resistance with the binder silicon content. The correlation coefficient for the relationship was 0.6915, indicating that there is a fair to good relationship between the wear resistance improvement and increased binder silicon content.

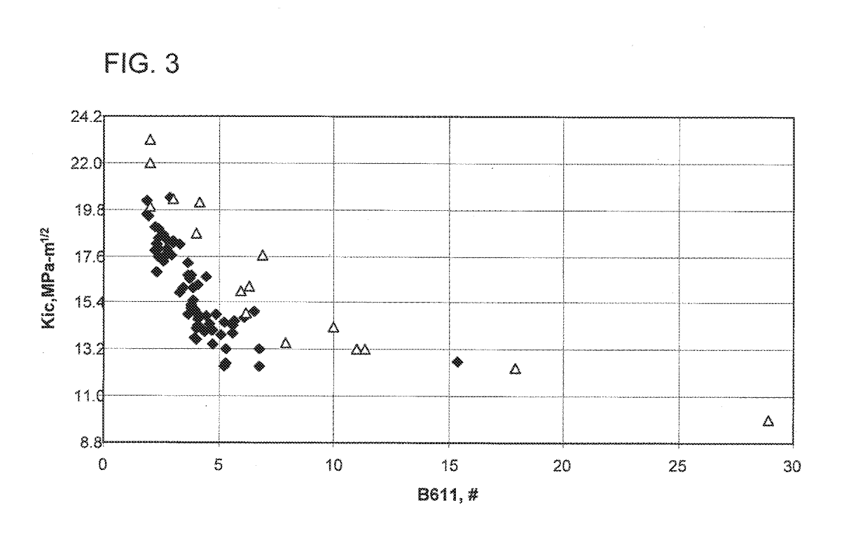

The inventor of the present invention also discovered the surprising result that the relationship between the fracture toughness and wear resistance for the cemented carbide can be adjusted by the use of a cobalt-silicon binder in tungsten carbide/cobalt cemented carbides. Referring to the fracture toughness (K_{IC}) versus wear resistance (B611#) plot shown in FIG. 3, the diamonds represent the relationship between the fracture toughness to wear resistance for commercial tungsten carbide/cobalt cemented carbides and the triangles the same relationship for the Example embodiments of the present invention discussed above. As can be seen, in general, it appears that the embodiments of the present invention have higher wear resistance for the same fracture toughness levels as compared to the commercial grades. In some cases, embodiments of the present invention have higher fracture toughness levels for the same wear resistance compared to the commercial cemented carbides.

While only a few embodiments of the present invention have been shown and described, it will be obvious to those skilled in the art that many changes and modifications may be made thereunto without departing from the spirit and scope of the present invention as described in the following claims. All patent applications, patents, and all other publications referenced herein are incorporated herein in their entireties to the full extent permitted by law.

What is claimed is:

1. A cemented carbide composition of matter consisting essentially of tungsten carbide particles and a cobalt-silicon alloy binder, wherein the silicon content of the cobalt-silicon alloy binder is in the range of from about 1 to about 21 weight percent, and the amount of the cobalt-silicon alloy binder is in the range of from about 1 to about 40 weight percent of the composition.

2. The cemented carbide composition of claim 1, wherein the amount of the cobalt-silicon alloy binder is in the range of about 3 to about 30 weight percent of the composition.

3. The cemented carbide composition of claim 1, wherein the tungsten carbide particles have an average particle size in the range of from about 0.2 to about 12 microns.

4. The cemented carbide composition of claim 1, wherein the silicon content in the cobalt-silicon alloy binder is in the range of from about 2 to about 13 weight percent.

5. A method for making a cemented carbide article comprising the steps of:
a) providing a milled powder consisting essentially of tungsten carbide, cobalt, and silicon and a pressing aid;
b) pressing the milled powder to form a compact; and
c) liquid phase sintering the compact to form the article;
wherein the amount of the silicon is in the range of from about 1 to about 21 percent of the combined weight of the silicon and the cobalt.

6. The method of claim 5, further comprising the step of milling together tungsten carbide powder with cobalt powder and silicon powder to create the milled powder.

7. The method of claim 5, wherein the article is one selected from the group consisting of a metal cutting tool insert, a road construction tool insert, an oil or gas drill insert, a mining tool insert, a substrate for an ultrahard material.

8. The method of claim 5, wherein the amount of the silicon is in the range of from about 2 to about 13 percent of the combined weight of the silicon and the cobalt.

9. The method of claim 5, further comprising the step of providing the tungsten carbide as a powder having an average particle size in the range of from about 0.6 to about 40 microns.

10. The method of claim 5, wherein the combined amount of the cobalt and silicon in the milled powder is in the range of from about 1 to about 40 weight percent of the combined weight of the tungsten, the cobalt, and the silicon.

11. A wear resistant article comprising cemented carbide, wherein the cemented carbide consists essentially of tungsten carbide particles and a cobalt-silicon alloy binder, wherein the silicon content is in the range of from about 1 to about 21 weight percent of the cobalt-silicon alloy binder, and the amount of the cobalt-silicon alloy binder is in the range of from about 1 to about 40 weight percent of the composition.

12. The wear resistant article of claim 11, wherein the amount of the cobalt-silicon alloy binder is in the range of from about 3 to about 30 weight percent of the composition.

13. The wear resistant article of claim 11, wherein the tungsten carbide particles have an average particle size in the range of from about 0.2 to about 12 microns.

14. The wear resistant article of claim 11, wherein the silicon content of the cobalt-silicon alloy binder is in the range of from about 2 to about 13 weight percent.

15. Sintered cemented carbide pellets consisting essentially of tungsten carbide particles and a cobalt-silicon alloy binder, wherein the silicon content of the cobalt-silicon alloy binder is in the range of from about 1 to about 15 weight percent, and the amount of the cobalt-silicon alloy binder is in the range of from about 1 to about 40 weight percent of the composition of the pellets.

16. The sintered cemented carbide pellets of claim 15, wherein the amount of the cobalt-silicon alloy binder is in the range of from about 3 to about 30 weight percent of the composition of the pellets.

17. The sintered cemented carbide pellets of claim 15, wherein the tungsten carbide particles have an average particle size in the range of from about 0.2 to about 12 microns.

18. The sintered cemented carbide pellets of claim 15, wherein the silicon content in the cobalt-silicon alloy binder is in the range of between about 2 and about 13 weight percent.

19. A hardfacing material comprising a hardfacing binder and sintered cemented carbide pellets, wherein the sintered cemented carbide pellets consist essentially of tungsten carbide particles and a pellet binder consisting essentially of a cobalt-silicon alloy, wherein the silicon content of the pellet binder is in the range of from about 1 and about 21 weight percent, and the amount of the pellet binder is in the range of from about 1 to about 10 weight percent of the composition of the pellets.

20. The hardfacing material of claim 19, wherein the hardfacing binder is a steel alloy.

21. The hardfacing material of claim 19, wherein the hardfacing binder is a cobalt-silicon alloy and the silicon content of the hardfacing binder is in the range of from about 2 to about 13 weight percent of the hardfacing binder.

22. The hardfacing material of claim 21, wherein the amount of hardfacing binder is in the range of about 31 to about 35 weight percent of the hardfacing material composition.

23. The hardfacing material of claim 19, wherein the tungsten carbide particles have an average particle size in the range of from about 0.2 to about 12 microns.

24. A hardfacing rod comprising sintered cemented carbide pellets consisting essentially of tungsten carbide particles and a cobalt-silicon alloy binder, wherein the silicon content of the cobalt-silicon alloy binder is in the range of from about 1 and about 21 weight percent, and the amount of the cobalt-silicon alloy binder is in the range of from about 1 to about 10 weight percent of the composition.

25. The hardfacing rod of claim 24, further comprising at least one selected from the group consisting of a flux, a silicon-manganese alloy, a niobium alloy, and a phenolic resin.

26. The hardfacing rod of claim 24, wherein the tungsten carbide particles have an average particle size in the range of from about 0.2 to about 12 microns.

27. The hardfacing rod of claim 24, wherein the silicon content in the cobalt-silicon alloy binder is in the range of between about 2 and about 13 weight percent.

28. A cutter element comprising a cutting portion and a substrate portion, the cutting portion comprising at least one ultrahard material selected from the group consisting of PCD, PCBN, and TSP, and the substrate portion comprising a cemented carbide consisting essentially of tungsten carbide particles and a cobalt-silicon alloy binder, wherein the silicon content of the cobalt-silicon alloy binder is in the range of from about 1 and about 21 weight percent, and the amount of the cobalt-silicon alloy binder is in the range of from about 1 to about 25 weight percent of the composition.

29. A method of making a cutter element comprising the steps of:
(a) providing a substrate having a surface, the substrate comprising a cemented carbide consisting essentially of tungsten carbide particles and a cobalt-silicon alloy binder, wherein the silicon content of the binder is in the range of from about 1 and about 21 weight percent, and the amount of the cobalt-silicon alloy binder is in the range of from about 1 to about 25 weight percent of the composition;
(b) applying to the substrate surface at least one ultrahard material selected from the group consisting of PCD and CBN; and
(c) subjecting the substrate to sufficient pressure and temperature to bond together the substrate and the ultrahard material.

30. The method of claim 29, wherein the ultrahard material is in the form of particulates.

31. The method of claim 29, wherein the ultrahard material is in the form of an article.
